(19) United States
(12) Patent Application Publication
(10) Pub. No.: US 2002/0131500 A1
(43) Pub. Date: Sep. 19, 2002

(54) Method for determining a motion vector for a video signal

(76) Inventors: Bhavan R. Gandhi, Vernon Hills, IL (US); Reji Mathew, Riverwood (AU); Jian Zhang, Enfield (AU); James E. Crenshaw, Palatine, IL (US)

Correspondence Address: MOTOROLA, INC., 1303 EAST ALGONQUIN ROAD, IL01/3RD, SCHAUMBURG, IL, 60196

(21) Appl. No.: 09/775,001

(22) Filed: Feb. 1, 2001

(51) Int. Cl. H04N 7/12; H04N 5/14; H04N 9/64

(52) U.S. Cl. 375/240.16; 348/699

(57) ABSTRACT

A method according to the invention includes the steps of determining a signature metric (601) for a portion of a first image (403). A second image (401) is searched (605) for at least one relative match of the signature metric, yielding one or more candidate regions. In a pixel domain, the one or more candidate regions are searched (607) for the portion of the first image to obtain a motion vector for the first image (403). The second image (401) is searched in a search window (407) that is smaller than the area of the second image (401).

### FIELD OF THE INVENTION

This invention relates to video signals, including but not limited to motion vectors for use in processing video signals.

### BACKGROUND OF THE INVENTION

Motion Estimation (ME) is a key component of many video compression techniques. The purpose of ME is to reduce temporal redundancy between frames of a video sequence in order to reduce the amount of bandwidth necessary to store and/or transmit a video message. An ME algorithm predicts image data for an image frame using one or more previous image frames. A difference image is computed by taking the arithmetic difference between the original pixel data and corresponding predicted pixel data. A difference image with large variations indicates little or no temporal redundancy between the image frames. A difference image with small variations indicates a high degree of temporal redundancy between image frames. The difference image represents a reduced temporal redundancy representation of the image frames that yields better coding efficiency, i.e., the ability to represent data with the fewest number of bits.

Block-based ME algorithms operate on blocks, or sections, of image data. A block of image data in a current frame is predicted by a block of data from a previous image frame. The ME algorithm outputs a motion vector for the block of image data that specifies the location of a best block match from a previous image frame. In video compression methods, motion vector information is compressed and transmitted or stored along with the compressed difference data.

Motion Estimation is one of the most computationally intensive functions in a video encoding system. Existing block-based ME techniques try to strike a compromise between the computational complexity of computing the motion vector and the accuracy of the motion vector.

Full Search ME (FSME) exhaustively compares a block in a current image frame to each pixel position located within a search window of a previously processed frame, referred to as a previous frame, to find a best match for the block in the previous frame. The accuracy of the block match at each pixel position is determined by measuring its corresponding distortion. A typical distortion measure used by block matching metrics is the sum of absolute difference (SAD) metric.

$$SAD = {\sum }_{n = 0}^{N - 1} {\sum }_{m = 0}^{M - 1} \vert {B}_{nm}^{c} - {B}_{nm}^{p} \vert , \qquad ( 1 )$$

where B^{c} is the block in the current image frame and B^{p} is a block in the previous image frame. The indices m and n index the pixels within a block of N rows and M columns. A small SAD value corresponds to a good block match, and a large SAD value corresponds to a poor block match. Full Search ME becomes prohibitive as the search window is increased. Large search windows are necessary for large image sequences that are prevalent in applications such as Digital Video Disc (DVD) and High Definition Television (HDTV). Large search windows are also necessary for images sequences with large camera motion such as panning and displacement, and for sequences where objects undergo large displacement between frames.

Many block-based ME algorithms tradeoff motion estimation quality for lower hardware and computational complexity. One way of reducing ME complexity is to modify the search pattern so that it is not an exhaustive search. Hierarchical ME (HME) is a reduced complexity motion estimation method that employs a less exhaustive search mechanism when compared to FSME. An example of an HME method is as follows. Image sequences are first decomposed into a hierarchy of resolutions. Motion estimation is performed by first computing motion vectors at the lowest image resolutions. These motion vectors are passed to the next higher image resolution where they are refined. This process is continued until motion vectors at the original image resolution are computed. The advantage of HME is its reduced computational complexity for computing motion vectors, which is a direct result of the efficiency of the hierarchical search pattern compared to the exhaustive full search ME. The effectiveness of the hierarchical method is based on the assumption that the block matching error field is monotonic, which is not necessarily true. As a result, the disadvantage of HME is that the hierarchical search pattern may compute motion vectors that do not accurately capture the motion of the image blocks, resulting in poor coding efficiency.

A reduced complexity motion estimation algorithm that is based on the concept of reducing motion vector candidates is a generalization of a three-step search (TSS) mechanism. Sparsely spaced motion vector candidates are tested by performing block matching. The direction of the best block match is used to further search another set of less sparsely spaced candidates. This process is iterated until a full resolution motion vector is computed. Similar to HME, the effectiveness of this technique is based on the assumption that the block matching error field is monotonic, which is not necessarily true. Therefore, similar to HME, TSS may calculate motion vectors that do not accurately capture the image block, resulting in poor coding efficiency.

A method for reducing computational complexity of motion estimation incorporates a simpler block matching metric. The SAD computation shown in equation (1) is a full matching metric in that every pixel location within the block contributes to the cost function. A decimated SAD metric is applied to compute the block matching cost function. Unlike the HME and TSS methods, an exhaustive search within a search window is performed. The set of specific pixels that contribute to the decimated metric may be a function of the search point. This method reduces the computational complexity of the motion estimation by one fourth compared to FSME utilizing a full SAD metric. The motion vector quality has been shown to be comparable to FSME. The computational savings, however, is not sufficient for applications that require large search windows.

A feature based block matching metric uses integral projections. Horizontal and vertical projections of a block are computed by summing individual pixels along block rows and block columns respectively. Horizontal and vertical projections are computed for a block in the current image frame and the block defined by the search point in a previous image frame. Distortion is computed by taking the sum of absolute difference of the projected data.

$$D = {\sum }_{n = 0}^{N - 1} \vert {H}_{n}^{c} - {H}_{n}^{p} \vert + {\sum }_{m = 0}^{M - 1} \vert {V}_{m}^{c} - {V}_{m}^{p} \vert \qquad ( 2 )$$

Equation (2) computes the distortion of matching a current block using horizontal and vertical projection data. H^{c}, H^{p}, V^{c}, and V^{p} represent horizontal projection data of the current block, horizontal projection data of a block in a previous frame, vertical projection data of a current block, and vertical projection data of a block in a previous frame, respectively. The indices m and n index the projected values for a block with N rows and M columns. This technique requires computing the projected data for the current block and all blocks defined by the search locations in the search window. This projection based metric may be used in conjunction with traditional block matching techniques to give a factor of two improvement in computational complexity. Using this metric for full search may reduce its computational complexity by a factor of eight, which is still insufficient for searching large search windows. Integrating this metric with HME and TSS motion estimation is limited by the effectiveness of the search pattern. The computational complexity savings are limited by allowable pre-processing. Because none of the projection computations are done by a pre-processing step, the computational savings are limited. Another drawback of this technique is that the final motion vector is determined using the match metric in projection space, i.e., using horizontal and vertical projection data, which projection data gives only a course representation of the actual pixel data.

A two-stage motion estimation algorithm was designed for wide area search ranges. This algorithm is comprised of a first stage that determines two smaller search windows within a large search window. The first small search window is centered around the zeroth motion vector, which is the current location of the block in question. The second search window is centered around a motion vector determined by motion vector history of previously processed blocks. The two smaller search windows are exhaustively searched using an adaptively sub-sampled SAD metric. A sub-sampling mask is computed for each block in the current image frame. A mask location is set to unity if the spatial position corresponds to the maximum and minimum pixel values in each block column. Following this process, thirty-two locations (two for each block column) are set to unity and the other locations are set to zero. The SAD metric is computed using the pixel locations tagged with unity. Because this mask is updated for every block, this metric is referred to as an adaptively sub-sampled SAD metric. The advantage of this technique is its computational efficiency in computing large displacement motion vectors. The disadvantage is the inaccuracy of the computed motion vectors. The first stage uses only motion vector history for determining the non-zero search window, which may result in pointing to erroneous regions in the large search windows. The second stage uses a sub-sampled SAD metric, which trades motion vector quality for computational efficiency.

Accordingly, there is a need for a method to compute motion vectors that accurately captures an image block, is efficient to code, is computationally efficient, even for large search windows, and provides an accurate motion vector.

### BRIEF DESCRIPTION OF THE DRAWINGS

FIG. 1 is a block diagram of a video compression system in accordance with the invention.

FIG. 2 is a block diagram of a motion estimation system in accordance with the invention.

FIG. 3 shows a representation of a signature metric for an image block in relation to an image frame in accordance with the invention.

FIG. 4 shows a search window for a block of interest in a current image frame and a reference image frame in accordance with the invention.

FIG. 5 shows a motion vector within a reference image frame showing two search regions in the pixel domain in accordance with the invention.

FIG. 6 is a flowchart showing a method of a computing a motion vector in accordance with the invention.

### DESCRIPTION OF A PREFERRED EMBODIMENTS

The following describes an apparatus for and method of determining a motion vector for a video signal. A multi-stage motion estimation process projects pixel data of a region in a frame into representative projection information to obtain a coarse motion vector, and pixel projection is utilized to refine the motion vector. In the preferred embodiment, regions are blocks and projected information is comprised of vertical and horizontal projection data representative of the block. Coarse motion vectors are computed for the block in a current image frame using its projected representation. Projected information of the block in the current image frame is compared to projected representation of blocks in a large search window in a previously processed image frame. The output of this step is a set of motion vectors specifying a set of best block matches in the projection data space. In the preferred embodiment, a single best motion vector is determined in this step. A refined motion vector is computed for the block by searching smaller search regions within the large search window of the first stage in the pixel domain. The first search region is around the zeroth motion vector of the current block, and the other search regions are defined by the motion vectors computed during the first step. Because the first step of the preferred embodiment specifies one motion vector, only one other search region is defined in addition to the first search region. Pixel locations within each of the two search regions are examined to determine the best motion vector. A pixel based block matching metric such as the SAD or the decimated SAD may be used to determine the best matched block. In selecting the motion vector, either the best matched motion vector may be chosen or a preference may be given to motion vectors of one search region over another.

Generally, a method according to the invention comprises the steps of determining a signature metric for a portion of a first image; searching a second image for at least one relative match of the signature metric, yielding one or more candidate regions; and, in a pixel domain, searching the one or more candidate regions for the portion of the first image to obtain a motion vector for the portion of the first image. In the preferred embodiment, the portion of the first image is in signature space and the signature metric comprises a vertical signature metric, comprising vertically projected image data, and a horizontal signature metric, comprising horizontally projected image data. The second image is searched in a search window that is smaller than the area of the second image. A region defined by a zeroth motion vector may also be searched, yielding an additional motion vector, and the motion vector and the additional motion vector may be compared, yielding a better motion vector.

An apparatus of the present invention comprises a projection data comparator, arranged and constructed to compare a signature metric for a portion of a first image to projected data in a search window of a second image, yielding at least one coarse motion vector, and a pixel domain comparator, arranged and constructed to, on a pixel basis, search at least one region related to the at least one coarse motion vector for image data, yielding a fine motion vector. The apparatus may further comprise a signature metric determiner that provides a vertical signature metric and a horizontal signature metric. The pixel domain comparator may be further arranged and constructed to yield a first motion vector and a second motion vector, and to compare the first motion vector and the second motion vector to find a better motion vector, yielding a final motion vector.

International video compression standards, such as H.263, MPEG-2, and MPEG-4, allow block-based ME by providing a syntax for specifying motion vectors. These standards do not require specific ME algorithms. Within these compression standards, motion estimation is computed on a base block size of 16×16 pixels, denoted as a macroblock. Allowances to operate on block sizes of 8×8 pixels to estimate motion for smaller image regions are provided. Parts, segments, or regions of images or image frames are referred to herein generally as blocks. In the preferred embodiment, the height and width of each block is the same as the height of a single macroblock, i.e., 16×16 pixels.

A block diagram of a video compression system is depicted in FIG. 1. This diagram shows the location of the motion estimation (ME) stage 101 in a typical video encoder. ME is computed for blocks of image data from a current image frame using one or more previously processed image frames. The motion estimation unit 101 outputs a motion vector corresponding to a processed block. A motion compensation (MC) unit 103 forms a prediction block comprised of predicted image data from the previous frame using computed motion vectors.

A difference image is computed by subtracting the predicted image data from the current image frame. The difference image is transformed by a DCT (discrete cosine transform) block 109 using a discrete cosine transform, as is known in the art to produce DCT coefficients. Whereas the ME and MC units serve to reduce temporal redundancy between image frames, the DCT block 109 serves to reduce the spatial redundancy within a frame. The DCT coefficients are subsequently subject to reduced precision by a quantizer unit 111. The quantizer 111 reduces the precision needed to represent the DCT coefficients by judiciously throwing away DCT coefficient information. As an example, an 8-bit (0 to 255) representation of a DCT coefficient divided by quantizer value of 16 results in a 4-bit representation (0 to 15). The effect of the quantizer 111 is to increase compression efficiency while introducing numerical loss. The quantized DCT coefficients are encoded by a variable length code (VLC) encoder 113 and transmitted in a compressed video bitstream along with the motion vectors. A local reconstruction loop is comprised of an inverse quantizer 119, an inverse DCT (IDCT) 117, and an adder 115. The inverse quantizer 119 reconstructs the DCT coefficients. The IDCT 117 transforms the DCT coefficients back into the spatial domain to form a quantized difference image. The reconstructed frame is computed by adding the motion compensated data to the quantized difference image at the adder 115. The reconstructed data is stored for use in processing subsequent image frames.

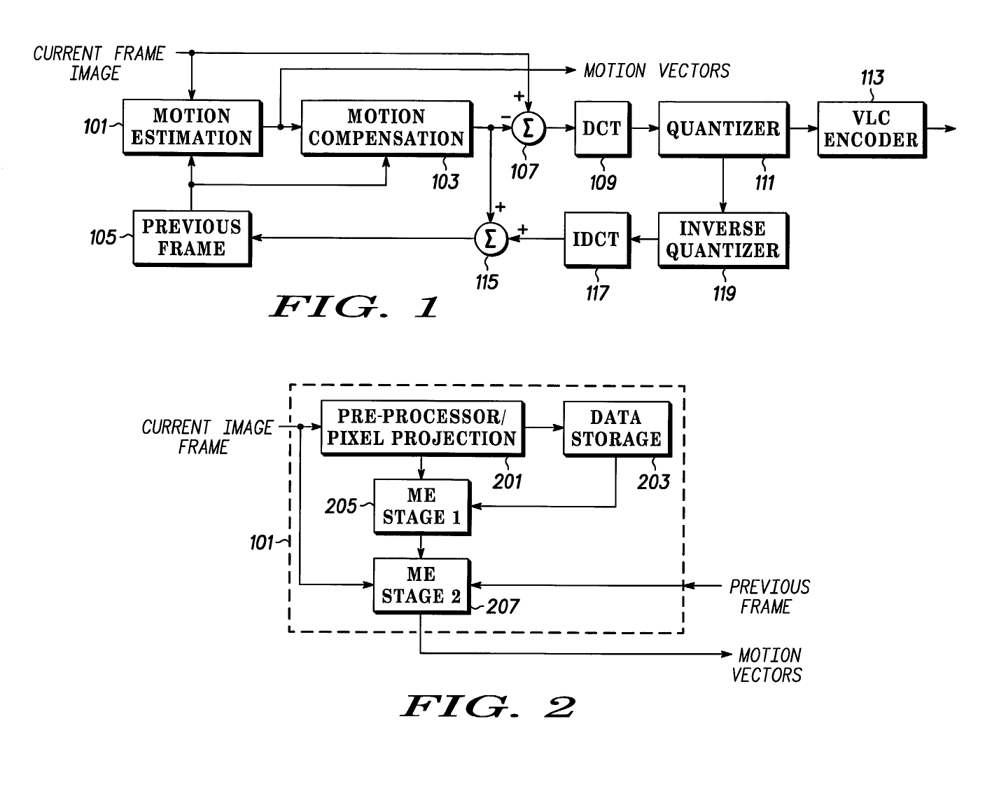

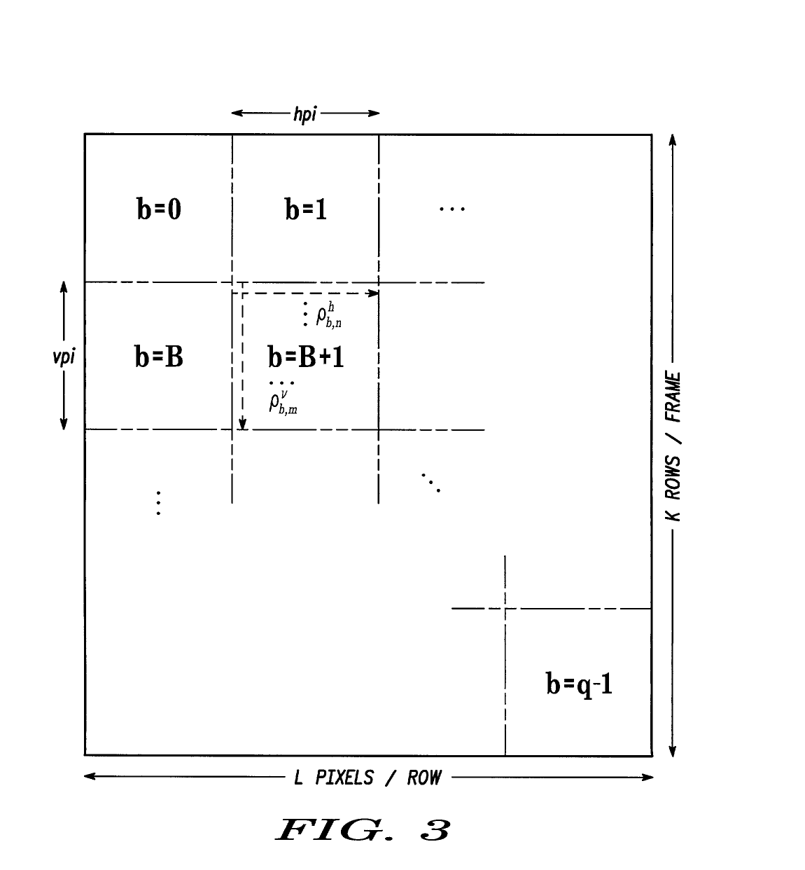

The block diagram of a motion estimation system is shown in FIG. 2. A current image frame of a video sequence along with a previously processed image are inputs to the motion estimation unit 101. The current image frame is processed by a pre-processor unit 201. The pre-processor unit 201 computes two-dimensional (2-D) pixel projection data, i.e., vertical and horizontal projection data, hereinafter referred to as a signature metric(s), that is passed to a data storage unit 203 for future use. See FIG. 3 and its associated text for more details. The data storage unit 203 is a memory buffer capable of storing the 2-D projection (signature metric) data for previously processed image frames.

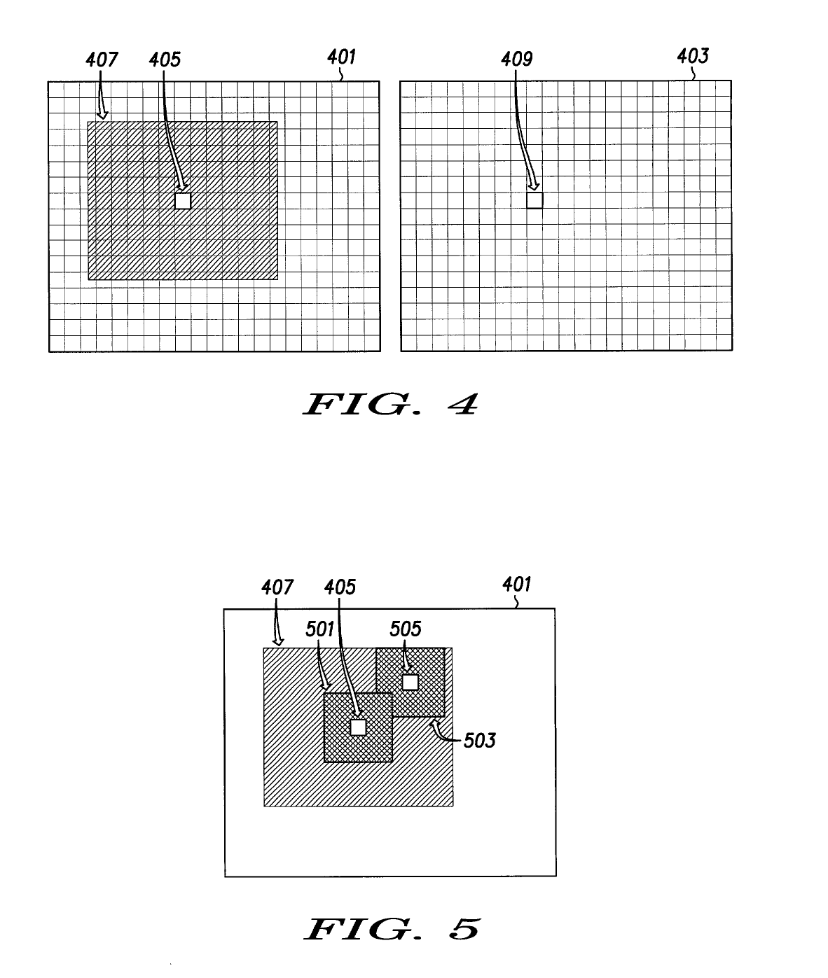

The 2-D projected (signature metric) data for the current frame is also passed to an ME stage 1 unit 205, also referred to generally as a projection data comparator. The ME stage 1 unit 205 computes a motion vector for each block in the current frame using 2-D projected image data by comparing it with 2-D projected image data for blocks in a search window (see the search window 407 in FIG. 4) in a previously processed image frame. See FIG. 4 and its associated text for more details on how the ME stage 1 unit 205 operates. The motion vector computed by the ME stage 1 unit 205 is passed to an ME stage 2 unit 207, also referred to generally as a pixel domain comparator, along with the current image data and the previously processed image data. Although one motion vector is computed by the ME stage 1 unit 205 in the preferred embodiment, addition motion vectors may be computed, and each motion vector would then be processed by the ME stage 2 unit 207 to determine the final motion vector that is output by the ME stage 2 unit 207.

The ME stage 2 unit 207 computes a refined motion vector for each block in the current frame by performing block searches in two small search regions (see the windows 501 and 503 in FIG. 5) bounded the search window 407 used in the ME stage 1 unit 205. The search performed by the ME stage 2 unit 207 is performed in the pixel domain, i.e., on a pixel-by-pixel basis or utilizing pixel data. The first small search region is around the zeroth motion vector, i.e., around the current block location. The second search region is around the motion vector computed in the ME stage I unit 205. If additional motion vectors are computed by the ME stage 1 unit 205, search regions around these motion vectors are searched. Traditional block matching techniques are used to search each of the two (or more) search regions for the best motion vector. In the preferred embodiment, one motion vector is computed for each search region, thus two candidate motion vectors are calculated. A motion vector corresponding to the smallest matching error is selected from the two (or more) candidate motion vectors. See FIG. 5 and its associated text for more details on how the ME stage 2 unit 207 operates. This motion vector is passed to the motion compensation unit 103. The motion vector is also coded for transmission with a compressed video bit-stream by the VLC encoder 113.

A representation of a signature metric (projection data), as determined by the pre-processor block 201 for an image block in relation to an image frame, is shown in FIG. 3. In the preferred embodiment of the pre-processor step, an image frame having K rows/frame and L pixels/row is partitioned into q blocks, where K, L, and q are integers greater than zero. Vertical projection data for each block is computed by summing the pixels along the columns within each block as shown in Equation (3):

$${ρ}_{b , m}^{v} = {\sum }_{j = ( \frac{b}{B} ) hpi}^{j < ( \frac{b}{B} ) hpi + Blk\_Height} {I}_{i , j} , \qquad ( 3 )$$

where 0≦m<Blk_Width, i=(b Mod B)vpi+m, Blk_Height=the number of vertical pixels in a block, and Blk_Width=the number of horizontal pixels in a block. I_{i,j} represents the image pixel value at row i and column j. The index b corresponds to the block number that is increasing numerically from 0 to q−1 in a raster ordered fashion from the top left of the image frame to the bottom right of the image frame. B corresponds to the number of blocks spanning the width of the image frame. The terms vpi and hpi correspond to vertical projection interval and horizontal projection interval respectively. For non-overlapping blocks in the vertical direction, vpi is greater than or equal to the block height (Blk_Height) in number of pixels. For overlapping blocks in the vertical direction, vpi is a value less than the block height (Blk_Height) in number of pixels. ρ^{v}_{b,m}, also known as a vertical signature metric, represents the vertically projected data value corresponding to a block, b, and a block column, m.

Horizontal projection data for each block is computed by summing the pixels along the rows within each block as shown in Equation (4).

$${ρ}_{b , n}^{h} = {\sum }_{i = ( b Mod B ) vpi}^{i < ( b Mod B ) vpi + Blk\_Width} {I}_{i , j} , \qquad ( 4 )$$

where 0≦n<Blk_Height, j=(b/B)hpi+n, Blk_Height=the number of vertical pixels in a block, and Blk_Width=the number of horizontal pixels in a block. In Equation 4, I_{i,j} represents the image pixel value at row i and column j. For non-overlapping blocks in the vertical direction, hpi is set to the block width in number of pixels. For overlapping blocks in the horizontal direction, hpi is a value less than the block width in number of pixels. ρ^{h}_{b,n}, also known as a horizontal signature metric, represents the horizontally projected data value corresponding to a block, b, and a block column, n.

In the preferred embodiment, vpi is assumed to be equal to the block height and hpi is assumed to be equal to the block width, thus assuming non-overlapping blocks in both vertical and horizontal directions. Generally, vpi may take on any value between one and the image height in pixels, and hpi may take on any value between one and the image width in pixels. Other values for vpi and hpi may be chosen as appropriate, such as less than block height and less than block width, respectively. Also, any combination of projection data, i.e., signature metrics, may be used to represent the region in projection space, although vertical and horizontal projection data are typically weighted equally.

A search window for a block that is referenced in both in a reference image frame 401 and a current image frame 403 is shown in FIG. 4. The ME stage 1 unit 205 computes a motion vector using the signature metrics, also referred to as 2-D projection data, as determined by the pre-processor 201. A block 409 in the current image frame, represented by its 2-D projection data (signature metric), is compared to 2-D projected data (signature metrics) of blocks in a search window 407 in the reference frame, which is a previously processed frame. The search window 407 is typically centered about the location 405 that corresponds to the location of the block 409 in the current image frame. In the preferred embodiment, blocks must be entirely within the search window 407 for consideration as part of the search space. The search window 407 is searched to find the best match with the projected representation of the block.

Equation (5) shows the match metric that is used for comparing a block to signature metrics of blocks in the search window 407 using vertically and horizontally projected data.

$${SAD}_{b}^{MB} = {\sum }_{m = 0}^{M - 1} \vert {ρ}_{MB , m}^{v} - {ρ}_{b , m}^{v} \vert + {\sum }_{n = 0}^{N - 1} \vert {ρ}_{MB , n}^{h} - {ρ}_{b , n}^{h} \vert \qquad ( 5 )$$

In the preferred embodiment, the match metric is computed for all block locations within the large search window, although other embodiments may find success in computing the match metric for less than all of the block locations. The vertically projected data, or vertical signature metric for the block, ρ^{v}_{MB,m}, is compared to vertically projected data of a block b, ρ^{v}_{b,m,} within the search window 407. The horizontally projected data, or horizontal signature metric for the block, ρ^{h}_{MB,n}, is compared to horizontally projected data of a block b, ρ^{h}_{b,m}, within the large search window 407.

The location of the block corresponding to the minimum distortion in the search window 407 defines the motion vector for the first stage, MVₛ₁. Although the described projected data can be used to provide a motion vector to any pixel in the search window, the granularity of the motion vector is hpi in the horizontal direction, and vpi in the vertical direction. In the preferred embodiment, hpi and vpi are equal to the block width and height, respectively, which is the granularity of the horizontal and vertical components of the motion vector.

The first stage motion vector, MVₛ₁, is input to the ME stage 2 unit 207, which conducts a refined motion vector search is in two small search windows 501 and 503 contained within the search window 407, as shown in FIG. 5. The first search window 501 is located around the zeroth motion vector. The second search window 503 is defined by MVₛ₁. In the preferred embodiment, a decimated SAD metric is used to compute the best matched vector in both search windows using an exhaustive search. An example of a decimated SAD metric, where one fourth of the pixels in a block are used to compute the block matching metric, is given in equation (6).

$$SAD = {\sum }_{{n = 0}_{n ∈ odd}}^{N - 1} {\sum }_{{m = 0}_{m ∈ even}}^{M - 1} \vert {B}_{nm}^{c} - {B}_{nm}^{p} \vert , \qquad ( 6 )$$

Other techniques well known in the art may also be used for computing motion vectors in the small search windows. Of the two or more candidate motion vectors, the motion vector corresponding to the best matched block is selected. One may also devise alternate selection criteria such as biasing the search region to the zeroth motion vector.

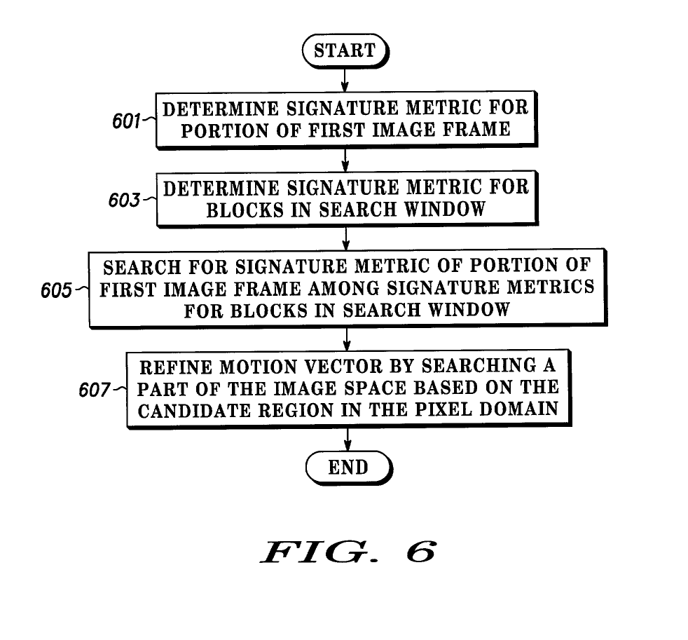

A flowchart showing a method of a computing a motion vector is shown in FIG. 6. At step 601, a signature metric, as described with respect to the pre-processor 201, is determined for a portion or block of a first image frame. At step 601, signature metrics for each block in a search window 407 are similarly computed. At step 605, the signature metric of the block is searched for among the signature metrics for the blocks in the search window 407, yielding one or more coarse motion vectors. At step 607, the one or more coarse motion vectors are refined by searching, in image space, i.e., in the pixel domain, candidate regions related to the one or more coarse motion vectors, yielding one or more fine motion vectors. In addition, a candidate region related to the zeroth motion vector is also search in the preferred embodiment, yielding another fine motion vector. All of the fine motion vectors are compared to find which candidate is best by comparing the corresponding match metrics in pixel space, yielding a final motion vector that is output by the ME unit 101.

The motion estimation unit 101 may be implemented as hardware, for example in the form of an ASIC (Application Specific Integrated Circuit), discrete circuitry, or other type of hardware, or it may implemented in software on a variety of general purpose processors, such as that found in PC/Windows and Unix based systems.

The present invention provides a good compromise between computational complexity and the accuracy of motion vectors. Prediction error, and hence motion vector accuracy, is measured by computing the arithmetic difference between original block data and its predicted value. Hardware complexity is greatly reduced over FSME methods. The present method is efficient to code as well as computationally efficient, even for large search windows, while providing an accurate motion vector. The invention is particularly useful for consumer bit-rate, consumer quality video compression applications, which demand good temporal prediction for efficient compression while maintaining a computational complexity that is markedly lower than FSME techniques.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising the steps of:
determining a signature metric for a portion of a first image;
searching a second image for at least one relative match of the signature metric, yielding one or more candidate regions;
in a pixel domain, searching at least one of the one or more candidate regions for the portion of the first image to obtain a motion vector for the portion of the first image.

2. The method of claim 1, wherein the portion of the first image is in signature space.

3. The method of claim 1, wherein the step of determining the signature metric comprises determining a vertical signature metric and a horizontal signature metric.

4. The method of claim 3, wherein the vertical signature metric comprises vertically projected image data.

5. The method of claim 3, wherein the horizontal signature metric comprises horizontally projected image data.

6. The method of claim 1, wherein the step of searching the second image comprises searching less than all of the second image.

7. The method of claim 1, wherein the step of searching in the pixel domain further comprises the step of searching a region defined by a zeroth motion vector, yielding an additional motion vector.

8. The method of claim 7, further comprising the step of comparing the motion vector and the additional motion vector, yielding a final motion vector.

9. A method comprising the steps of:
employing a portion of a signature space to identify a candidate region in an image space of a possible relative match with a current image; and
searching a part of the image space based at least in part on a portion of the candidate region to obtain a motion vector for at least a part of the current image.

10. The method of claim 9, further comprising the step of determining a signature metric.

11. The method of claim 10, wherein the step of determining the signature metric comprises determining a vertical signature metric and a horizontal signature metric.

12. The method of claim 11, wherein the vertical signature metric comprises vertically projected image data.

13. The method of claim 11, wherein the horizontal signature metric comprises horizontally projected image data.

14. The method of claim 9, wherein the step of searching the part of the image space further comprises the step of searching a region defined by a zeroth motion vector, yielding an additional motion vector.

15. The method of claim 14, further comprising the step of comparing the motion vector and the additional motion vector, yielding a final motion vector.

16. A method comprising the steps of:
comparing a signature metric for a portion of a first image to projected data in a search window of a second image, yielding at least one coarse motion vector;
on a pixel basis, searching at least one region related to the at least one coarse motion vector for image data, yielding a fine motion vector.

17. The method of claim 16, further comprising the step of determining a signature metric that comprises a vertical signature metric and a horizontal signature metric.

18. The method of claim 16, wherein the search window is smaller than all of the second image.

19. The method of claim 17, wherein the step of searching further comprises the step of searching a region defined by a zeroth motion vector, yielding a first motion vector.

20. The method of claim 18, wherein the step of searching the at least one region yields a second motion vector, and the first motion vector and the second motion vector are compared to find a better motion vector, yielding a final motion vector.

21. An apparatus comprising:
a projection data comparator, arranged and constructed to compare a signature metric for a portion of a first image to projected data in a search window of a second image, yielding at least one coarse motion vector; and
a pixel domain comparator, arranged and constructed to, on a pixel basis, search at least one region related to the at least one coarse motion vector for image data, yielding a fine motion vector.

22. The apparatus of claim 21, further comprising a signature metric determiner that provides a vertical signature metric and a horizontal signature metric.

23. The apparatus of claim 21, wherein the pixel domain comparator is further arranged and constructed to yield a first motion vector and a second motion vector, and to compare the first motion vector and the second motion vector to find a better motion vector, yielding a final motion vector.
